(19) United States
(12) Patent Application Publication
(10) Pub. No.: US 2022/0272790 A1
(43) Pub. Date: Aug. 25, 2022

(54) Discontinuous Transmission, DTX, Detection

(71) Applicant: Nokia Technologies Oy, Espoo (FI)

(72) Inventors: John HARRIS, Whitefish Bay, WI (US); Roy YANG, Buffalo Grove, IL (US)

(21) Appl. No.: 17/597,441

(22) PCT Filed: Jul. 8, 2019
(86) PCT No.: PCT/EP2019/068256

§ 371 Date: Jan. 6, 2022

(51) Int. Cl. H04W 76/28

(52) U.S. Cl. CPC H04W 76/28

(57) ABSTRACT

There is disclosed a method including at a serving cell, using cell measurements performed at a neighbouring cell to assist the serving cell in determining whether a serving cell user equipment which supports skip-uplink is in a discontinuous transmission state. The cell measurements performed at the neighbouring cell include measurements of the serving cell user equipment.

### FIELD

This disclosure relates to cellular radio communications. More particularly the present invention relates to determining a discontinuous transmission state of a user equipment.

### BACKGROUND

A communication system can be seen as a facility that enables communication between two or more devices such as user terminals, machine-like terminals, base stations and/or other nodes by providing communication channels for carrying information between the communicating devices. A communication system can be provided for example by means of a communication network and one or more compatible communication devices. The communication may comprise, for example, communication of data for carrying data for voice, electronic mail (email), text message, multimedia and/or content data communications and so on. Non-limiting examples of services provided include two-way or multi-way calls, data communication or multimedia services and access to a data network system, such as the Internet.

A communication system and associated devices typically operate in accordance with a given standard or specification which sets out what the various entities associated with the system are permitted to do and how that should be achieved. Communication protocols and/or parameters which shall be used for the connection are also typically defined. Non-limiting examples of standardised radio access technologies include GSM (Global System for Mobile), EDGE (Enhanced Data for GSM Evolution) Radio Access Networks (GERAN), Universal Terrestrial Radio Access Networks (UTRAN) and evolved UTRAN (E-UTRAN). An example communication system architecture is the long-term evolution (LTE) of the Universal Mobile Telecommunications System (UMTS) radio-access technology. The LTE is standardized by the third Generation Partnership Project (3GPP). The LTE employs the Evolved Universal Terrestrial Radio Access Network (E-UTRAN) access and a further development thereof which is sometimes referred to as LTE Advanced (LTE-A).

Since introduction of fourth generation (4G) services increasing interest has been paid to the next, or fifth generation (5G) standard. 5G may also be referred to as a New Radio (NR) network.

### Examples

According some aspects, there is provided the subject matter of the independent claims. Some further aspects are defined in the dependent claims. Embodiments that do not fall under the scope of the claims are to be interpreted as examples useful for understanding the disclosure.

According to a first aspect there is disclosed a method comprising: at a serving cell, using cell measurements performed at a neighbouring cell to assist the serving cell in determining whether a serving cell user equipment which supports skip-uplink is in a discontinuous transmission state, wherein the cell measurements performed at the neighbouring cell comprise measurements of the serving cell user equipment.

According to an example, the method comprises the serving cell performing cell measurements of the serving cell user equipment, and the determining whether the serving cell user equipment is in a discontinuous transmission state comprises performing a comparison of the cell measurements performed by the serving cell and the cell measurements performed at the neighbouring cell.

According to an example, the method comprises determining that the serving cell user equipment is in the discontinuous transmission state when both the cell measurements performed by the serving cell and the cell measurements performed at the neighbouring cell indicate that the serving cell user equipment is in a discontinuous transmission state.

According to an example, the method comprises performing a joint reception procedure at the serving cell to determine whether the serving cell user equipment is in a discontinuous transmission state, when only one of the cell measurements performed by the serving cell and the cell measurements performed at the neighbouring cell indicate that the serving cell user equipment is in a discontinuous transmission state.

According to an example, the method comprises the joint reception procedure comprising pooling antenna signals of the serving cell and the neighbouring cell.

According to an example, the method comprises the serving cell sending a request to the neighbouring cell to perform the cell measurements of the serving cell user equipment.

According to an example, the request comprises information to assist the neighbouring cell to perform the cell measurements, wherein the information comprises one or more of: downlink ACK/NACK information; channel quality indicator information; channel format information; absolute signal to interference and noise ratio threshold information; relative signal to interference and noise ratio threshold information, wherein the relative signal to interference and noise ratio comprises a difference between a neighbouring cell user equipment signal to interference and noise ratio at that neighbouring cell, and the serving cell user equipment signal to interference and noise ratio at the neighbouring cell.

According to some examples the detected signal to interference and noise ratio is detected on one or more of: physical uplink shared channel; physical uplink control channel.

According to some examples, the determining whether a serving cell user equipment which supports skip-uplink is in a discontinuous transmission state comprises using a received indication from the neighbouring cell, wherein the received indication explicitly indicates whether the neighbouring cell considers the serving cell user equipment to be in the discontinuous transmission state.

According to an example, the serving cell comprises a base station.

According to a second aspect there is provided a method comprising: at a neighbouring cell, performing cell measurements of a serving cell user equipment which supports skip-uplink, and sending the cell measurements to the serving cell, the cell measurements sent to the serving cell being indicative of whether the serving cell user equipment is in a discontinuous transmission state.

According to an example, the performing cell measurements comprises the neighbouring cell further performing cell measurements of a neighbouring cell user equipment, and comparing a quality metric of the neighbouring cell user equipment and the serving cell user equipment.

According to an example, the quality metric comprises a signal to interference and noise ratio.

According to an example, the method comprises determining a difference in the quality metric between the neighbouring cell user equipment and the serving cell user equipment, and comparing the difference to a threshold value in order to assist in determining whether the serving cell user equipment is in a discontinuous state.

According to an example, the performing cell measurements comprises the neighbouring cell measuring an absolute value of signal to interference and noise ratio of the serving cell user equipment, when it is determined by the neighbouring cell that there is no neighbouring cell user equipment whose scheduling grant overlaps with that of the serving cell user equipment.

According to an example, the method comprises the neighbouring cell providing an explicit indication to the serving cell of whether the neighbouring cell considers the serving cell user equipment to be in the discontinuous transmission state.

According to an example, the neighbouring cell comprises a base station.

According to a third aspect there is provided a method comprising: at a user equipment which supports skip-uplink in a serving cell, receiving an uplink grant from a base station of the serving cell, and making quality metric information of the user equipment available to the base station of the serving cell and a base station of the neighbouring cell to assist in determination of whether the user equipment is in a discontinuous transmission state.

According to a fourth aspect there is provided a computer program comprising instructions for causing an apparatus to perform at least the following: at a serving cell, using cell measurements performed at a neighbouring cell to assist the serving cell in determining whether a serving cell user equipment which supports skip-uplink is in a discontinuous transmission state, wherein the cell measurements performed at the neighbouring cell comprise measurements of the serving cell user equipment.

According to a fifth aspect there is provided a computer program comprising instructions stored thereon for performing at least the following: at a serving cell, using cell measurements performed at a neighbouring cell to assist the serving cell in determining whether a serving cell user equipment which supports skip-uplink is in a discontinuous transmission state, wherein the cell measurements performed at the neighbouring cell comprise measurements of the serving cell user equipment.

According to a sixth aspect there is provided a non-transitory computer readable medium comprising program instructions for causing an apparatus to perform at least the following: at a serving cell, using cell measurements performed at a neighbouring cell to assist the serving cell in determining whether a serving cell user equipment which supports skip-uplink is in a discontinuous transmission state, wherein the cell measurements performed at the neighbouring cell comprise measurements of the serving cell user equipment.

According to a seventh aspect there is provided a non-transitory computer readable medium comprising program instructions stored thereon for performing at least the following: at a serving cell, using cell measurements performed at a neighbouring cell to assist the serving cell in determining whether a serving cell user equipment which supports skip-uplink is in a discontinuous transmission state, wherein the cell measurements performed at the neighbouring cell comprise measurements of the serving cell user equipment.

According to an eighth aspect there is provided a computer program comprising instructions for causing an apparatus to perform at least the following: at a neighbouring cell, performing cell measurements of a serving cell user equipment which supports skip-uplink, and sending the cell measurements to the serving cell, the cell measurements sent to the serving cell being indicative of whether the serving cell user equipment is in a discontinuous transmission state.

According to a ninth aspect there is provided a computer program comprising instructions stored thereon for performing at least the following: at a neighbouring cell, performing cell measurements of a serving cell user equipment which supports skip-uplink, and sending the cell measurements to the serving cell, the cell measurements sent to the serving cell being indicative of whether the serving cell user equipment is in a discontinuous transmission state.

According to a tenth aspect there is provided a non-transitory computer readable medium comprising program instructions for causing an apparatus to perform at least the following: at a neighbouring cell, performing cell measurements of a serving cell user equipment which supports skip-uplink, and sending the cell measurements to the serving cell, the cell measurements sent to the serving cell being indicative of whether the serving cell user equipment is in a discontinuous transmission state.

According to an eleventh aspect there is provided a non-transitory computer readable medium comprising program instructions stored thereon for performing at least the following: at a neighbouring cell, performing cell measurements of a serving cell user equipment which supports skip-uplink, and sending the cell measurements to the serving cell, the cell measurements sent to the serving cell being indicative of whether the serving cell user equipment is in a discontinuous transmission state.

According to a twelfth aspect there is provided a computer program comprising instructions for causing an apparatus to perform at least the following: at a user equipment which supports skip-uplink in a serving cell, receiving an uplink grant from a base station of the serving cell, and making quality metric information of the user equipment available to the base station of the serving cell and a base station of the neighbouring cell to assist in determination of whether the user equipment is in a discontinuous transmission state.

According to a thirteenth aspect there is provided there is provided a computer program comprising instructions stored thereon for performing at least the following: at a user equipment which supports skip-uplink in a serving cell, receiving an uplink grant from a base station of the serving cell, and making quality metric information of the user equipment available to the base station of the serving cell and a base station of the neighbouring cell to assist in determination of whether the user equipment is in a discontinuous transmission state.

According to a fourteenth aspect there is provided a non-transitory computer readable medium comprising program instructions for causing an apparatus to perform at least the following: at a user equipment which supports skip-uplink in a serving cell, receiving an uplink grant from a base station of the serving cell, and making quality metric information of the user equipment available to the base station of the serving cell and a base station of the neighbouring cell to assist in determination of whether the user equipment is in a discontinuous transmission state.

According to a fifteenth aspect there is provided a non-transitory computer readable medium comprising program instructions stored thereon for performing at least the following: at a user equipment which supports skip-uplink in a serving cell, receiving an uplink grant from a base station of the serving cell, and making quality metric information of the user equipment available to the base station of the serving cell and a base station of the neighbouring cell to assist in determination of whether the user equipment is in a discontinuous transmission state.

According to a sixteenth aspect there is provided an apparatus comprising means for performing: at a serving cell, using cell measurements performed at a neighbouring cell to assist the serving cell in determining whether a serving cell user equipment which supports skip-uplink is in a discontinuous transmission state, wherein the cell measurements performed at the neighbouring cell comprise measurements of the serving cell user equipment.

According to some examples, the means are further configured to perform cell measurements of the serving cell user equipment, and the determining whether the serving cell user equipment is in a discontinuous transmission state comprises performing a comparison of the cell measurements performed at the serving cell and the cell measurements performed at the neighbouring cell.

According to some examples, the means are further configured to perform determining that the serving cell user equipment is in the discontinuous transmission state when both the cell measurements performed at the serving cell and the cell measurements performed at the neighbouring cell indicate that the serving cell user equipment is in a discontinuous transmission state.

According to some examples, the means are further configured to perform a joint reception procedure at the serving cell to determine whether the serving cell user equipment is in a discontinuous transmission state, when only one of the cell measurements performed at the serving cell and the cell measurements performed at the neighbouring cell indicate that the serving cell user equipment is in a discontinuous transmission state.

According to some examples, the means are further configured to perform the joint reception procedure by pooling antenna signals of the serving cell and the neighbouring cell.

According to some examples, the means are further configured to perform sending a request to the neighbouring cell to perform the cell measurements of the serving cell user equipment.

According to some examples, the request comprises information to assist the neighbouring cell to perform the cell measurements, wherein the information comprises one or more of: downlink ACK/NACK information; channel quality indicator information; channel format information; absolute signal to interference and noise ratio threshold information; relative signal to interference and noise ratio threshold information, wherein the relative signal to interference and noise ratio comprises a difference between a neighbouring cell user equipment signal to interference and noise ratio at that neighbouring cell, and the serving cell user equipment signal to interference and noise ratio at the neighbouring cell.

According to some examples the means are further configured to perform detecting the signal to interference and noise ratio on one or more of: physical uplink shared channel; physical uplink control channel.

According to some examples, the means are further configured to perform determining whether a serving cell user equipment which supports skip-uplink is in a discontinuous transmission state by using a received indication from the neighbouring cell, wherein the received indication explicitly indicates whether the neighbouring cell considers the serving cell user equipment to be in the discontinuous transmission state.

According to some examples, the serving cell comprises the apparatus.

According to some examples, the apparatus comprises a base station.

According to some examples, the means comprises at least one processor; and at least one memory including computer program code; the at least one memory and the computer program code configured to, with the at least one processor, cause the performance of the apparatus.

According to a seventeenth aspect there is provided an apparatus comprising at least one processor; and at least one memory including computer program code; the at least one memory and the computer program code configured to, with the at least one processor, cause the apparatus at least to perform: at a serving cell, using cell measurements performed at a neighbouring cell to assist the serving cell in determining whether a serving cell user equipment which supports skip-uplink is in a discontinuous transmission state, wherein the cell measurements performed at the neighbouring cell comprise measurements of the serving cell user equipment.

According to some examples, the at least one memory and the computer program code configured to, with the at least one processor, cause the apparatus at least to perform cell measurements of the serving cell user equipment, and the determining whether the serving cell user equipment is in a discontinuous transmission state comprises performing a comparison of the cell measurements performed at the serving cell and the cell measurements performed at the neighbouring cell.

According to some examples, the at least one memory and the computer program code configured to, with the at least one processor, cause the apparatus at least to perform determining that the serving cell user equipment is in the discontinuous transmission state when both the cell measurements performed at the serving cell and the cell measurements performed at the neighbouring cell indicate that the serving cell user equipment is in a discontinuous transmission state.

According to some examples, the at least one memory and the computer program code configured to, with the at least one processor, cause the apparatus at least to perform a joint reception procedure at the serving cell to determine whether the serving cell user equipment is in a discontinuous transmission state, when only one of the cell measurements performed at the serving cell and the cell measurements performed at the neighbouring cell indicate that the serving cell user equipment is in a discontinuous transmission state.

According to some examples, the at least one memory and the computer program code configured to, with the at least one processor, cause the apparatus at least to perform the joint reception procedure by pooling antenna signals of the serving cell and the neighbouring cell.

According to some examples, the at least one memory and the computer program code configured to, with the at least one processor, cause the apparatus at least to perform sending a request to the neighbouring cell to perform the cell measurements of the serving cell user equipment.

According to some examples, the request comprises information to assist the neighbouring cell to perform the cell measurements, wherein the information comprises one or more of: downlink ACK/NACK information; channel quality indicator information; channel format information; absolute signal to interference and noise ratio threshold information; relative signal to interference and noise ratio threshold information, wherein the relative signal to interference and noise ratio comprises a difference between a neighbouring cell user equipment signal to interference and noise ratio at that neighbouring cell, and the serving cell user equipment signal to interference and noise ratio at the neighbouring cell.

According to some examples the at least one memory and the computer program code configured to, with the at least one processor, cause the apparatus at least to perform detecting the signal to interference and noise ratio on one or more of: physical uplink shared channel; physical uplink control channel.

According to some examples, the at least one memory and the computer program code configured to, with the at least one processor, cause the apparatus at least to perform determining whether a serving cell user equipment which supports skip-uplink is in a discontinuous transmission state by using a received indication from the neighbouring cell, wherein the received indication explicitly indicates whether the neighbouring cell considers the serving cell user equipment to be in the discontinuous transmission state.

According to some examples, the serving cell comprises the apparatus.

According to some examples, the apparatus comprises a base station.

According to an eighteenth aspect there is provided an apparatus comprising circuitry for, at a serving cell, using cell measurements performed at a neighbouring cell to assist the serving cell in determining whether a serving cell user equipment which supports skip-uplink is in a discontinuous transmission state, wherein the cell measurements performed at the neighbouring cell comprise measurements of the serving cell user equipment.

According to a nineteenth aspect there is provided an apparatus comprising means for performing: at a neighbouring cell, performing cell measurements of a serving cell user equipment which supports skip-uplink, and sending the cell measurements to the serving cell, the cell measurements sent to the serving cell being indicative of whether the serving cell user equipment is in a discontinuous transmission state.

According to an example, the means are further configured to further perform cell measurements of a neighbouring cell user equipment, and compare a quality metric of the neighbouring cell user equipment and the serving cell user equipment.

According to an example the quality metric comprises a signal to interference and noise ratio.

According to an example, the means are further configured to further perform determining a difference in the quality metric between the neighbouring cell user equipment and the serving cell user equipment, and comparing the difference to a threshold value in order to assist in determining whether the serving cell user equipment is in a discontinuous state.

According to an example, the means are further configured to perform measuring an absolute value of signal to interference and noise ratio of the serving cell user equipment, when it is determined by the neighbouring cell that there is no neighbouring cell user equipment whose scheduling grant overlaps with that of the serving cell user equipment.

According to an example, the means are further configured to perform providing an explicit indication to the serving cell of whether the neighbouring cell considers the serving cell user equipment to be in the discontinuous transmission state.

According to an example, the neighbouring cell comprises the apparatus.

According to an example, the apparatus comprises a base station.

According to an example, the means comprises at least one processor; and at least one memory including computer program code; the at least one memory and the computer program code configured to, with the at least one processor, cause the performance of the apparatus.

According to a twentieth aspect there is provided an apparatus comprising at least one processor; and at least one memory including computer program code; the at least one memory and the computer program code configured to, with the at least one processor, cause the apparatus at least to perform: at a neighbouring cell, performing cell measurements of a serving cell user equipment which supports skip-uplink, and sending the cell measurements to the serving cell, the cell measurements sent to the serving cell being indicative of whether the serving cell user equipment is in a discontinuous transmission state.

According to an example, the at least one memory and the computer program code configured to, with the at least one processor, cause the apparatus at least to perform cell measurements of a neighbouring cell user equipment, and compare a quality metric of the neighbouring cell user equipment and the serving cell user equipment.

According to an example the quality metric comprises a signal to interference and noise ratio.

According to an example, the at least one memory and the computer program code configured to, with the at least one processor, cause the apparatus at least to perform determining a difference in the quality metric between the neighbouring cell user equipment and the serving cell user equipment, and comparing the difference to a threshold value in order to assist in determining whether the serving cell user equipment is in a discontinuous state.

According to an example, the at least one memory and the computer program code configured to, with the at least one processor, cause the apparatus at least to perform measuring an absolute value of signal to interference and noise ratio of the serving cell user equipment, when it is determined by the neighbouring cell that there is no neighbouring cell user equipment whose scheduling grant overlaps with that of the serving cell user equipment.

According to an example, the at least one memory and the computer program code configured to, with the at least one processor, cause the apparatus at least to perform providing an explicit indication to the serving cell of whether the neighbouring cell considers the serving cell user equipment to be in the discontinuous transmission state.

According to an example, the neighbouring cell comprises the apparatus.

According to an example, the apparatus comprises a base station.

According to a twenty first aspect there is provided an apparatus comprising circuitry for, at a neighbouring cell, performing cell measurements of a serving cell user equipment which supports skip-uplink, and sending the cell measurements to the serving cell, the cell measurements sent to the serving cell being indicative of whether the serving cell user equipment is in a discontinuous transmission state.

According to a twenty second aspect there is provided an apparatus comprising means for performing: at a user equipment which supports skip-uplink in a serving cell, receiving an uplink grant from a base station of the serving cell, and making quality metric information of the user equipment available to the base station of the serving cell and a base station of the neighbouring cell to assist in determination of whether the user equipment is in a discontinuous transmission state.

According to an example the apparatus comprises the user equipment.

According to an example the means comprises at least one processor; and at least one memory including computer program code; the at least one memory and the computer program code configured to, with the at least one processor, cause the performance of the apparatus.

According to a twenty third aspect there is provided an apparatus comprising at least one processor; and at least one memory including computer program code; the at least one memory and the computer program code configured to, with the at least one processor, cause the apparatus at least to perform: at a user equipment which supports skip-uplink in a serving cell, receiving an uplink grant from a base station of the serving cell, and making quality metric information of the user equipment available to the base station of the serving cell and a base station of the neighbouring cell to assist in determination of whether the user equipment is in a discontinuous transmission state.

According to an example the apparatus comprises the user equipment.

According to a twenty fourth aspect there is provided an apparatus comprising circuitry for, at a user equipment which supports skip-uplink in a serving cell, receiving an uplink grant from a base station of the serving cell, and making quality metric information of the user equipment available to the base station of the serving cell and a base station of the neighbouring cell to assist in determination of whether the user equipment is in a discontinuous transmission state.

### BRIEF DESCRIPTION OF FIGURES

The invention will now be described in further detail, by way of example only, with reference to the following examples and accompanying drawings, in which:

FIG. 1 shows a schematic example of parts of a wireless communication system where the invention may be implemented;

FIG. 2 shows a schematic example of parts of a wireless communication system where the invention may be implemented;

FIG. 3 shows a signalling diagram according to an example;

FIG. 4 schematically shows a flow-chart of a method according to an example;

FIG. 5 schematically shows a flow-chart of a method according to an example;

FIG. 6 schematically shows a table of of PRB number, n, against usage of that PRB according to an example;

FIG. 7 schematically shows a user equipment according to an example;

FIG. 8 schematically shows a control apparatus according to an example;

FIG. 9 schematically shows a flow chart of a method according to an example;

FIG. 10 schematically shows a flow chart of a method according to an example;

FIG. 11 schematically shows a flow chart of a method according to an example.

### DETAILED DESCRIPTION

As is known, wireless systems can be divided into cells, and are therefore often referred to as cellular systems. Typically, a base station provides at least one cell. The cellular system can support communications between user equipment (UE). The present disclosure relates to cellular radio implementation, including 2G, 3G, 4G, and 5G radio access networks (RANs); cellular internet of things (IoT) RAN; and cellular radio hardware.

3GPP Release 14 and beyond introduced a feature called “Skip Uplink”. This feature was introduced in the UE-EUTRA-Capability field (where EUTRA is an acronym of Evolved Universal Terrestrial Radio Access). The skip uplink feature allows a UE to skip or omit uplink (UL) transmission when there is no uplink data to transmit, even if a UL grant has been received by the UE.

Two other features that are useful in understanding the present invention are Discontinuous Transmission (DTX), and Uplink Coordinated Multi-Point (ULCoMP). DTX is a mechanism where transmissions from a UE are stopped or muted when there is no information (e.g. voice or data) to transmit from the UE. The resources will not be used while a user is silent, for example from the perspective that it reduces the amount of interference produced by that UE on the uplink while the UE is DTXed. In ULCoMP a number of RX-points receive the UL data from one UE, and the received data is combined to improve the quality.

As briefly discussed above, 3GPP Release 14 introduced a new feature in the UE-EUTRA-Capability field that allows the UE to skip uplink transmission when there is no uplink data to transmit, even if a UL grant is received. Specifically, in 3GPP 36.331 Chapter 6.3.6, two new parameters were added to the UE-Capability Information Elements, as follows:

(1) “skipUplinkDynamic”: this indicates whether the UE supports skipping of UL transmission for an uplink grant indicated on PDCCH (Physical Downlink Control Channel) if no data is available for transmission, as described in 3GPP TS 36.321

(2) “skipUplinkSPS” (SPS=semi-persistent scheduling). This indicates whether the UE supports skipping of UL transmission for a configured uplink grant if no data is available for transmission, as described in 3GPP TS 36.321.

It should also be noted that skipUplinkDynamic is also supported in 5GNR in 3GPP TS 38.331.

For any R14 or later UE with either or both of the above two parameters (skipUplinkDynamic and skipUplinkSPS) enabled, the UE can ignore the UL grant in PDCCH if it doesn't have any uplink data to send. In this case, the base station (e.g. eNB or gNB) that sends the UL grant will detect a DTX when it tries to decode the PUSCH (physical uplink shared channel).

Prior to Release 14, a UE would always respond to the UL grant in PDCCH with a PUSCH transmission, even if the UE had no data. For example the UE would send “dummy” data and mark in the media access control (MAC) header that the true data size is zero. The only scenario that the base station would detect DTX is when the UE didn't receive the UL grant due to channel degradation.

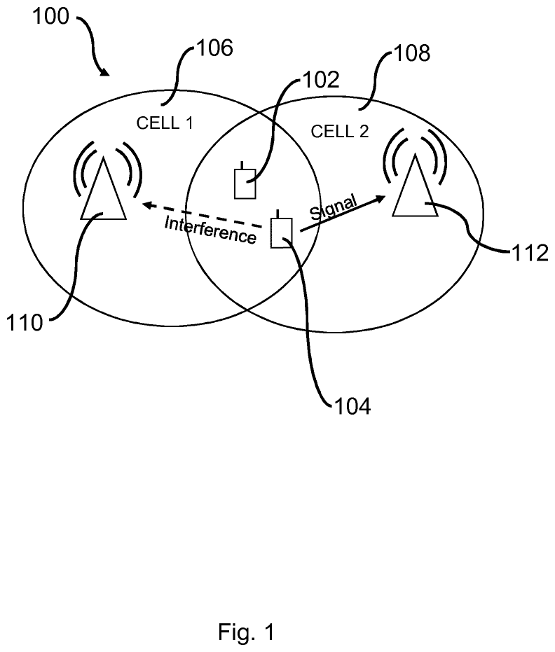

The present invention has identified that with the skip-uplink (which may also be referred to interchangeably with the equivalent term “UplinkSkip”) feature there are several new challenges in reliably detecting DTX, discussed as 1) to 4) below:
1) The base station faces more ambiguities when it tries to detect PUSCH, namely:
   “legitimate” DTX when the UE has nothing to send and skips the uplink transmission, i.e. UE will not send buffer status report (BSR)=0 and eNB needs to treat such lack of report as a normal situation;
   “illegitimate” DTX when the UE fails to detect UL grant due to channel degradation (even though the UE may have data to send);
   “False DTX detection” when the eNB mistakenly detects UL PUSCH transmission even though the UE sends DTX. Even though it is most likely a failed transmission with cyclic redundancy check (CRC) error, it may trigger unnecessary retransmissions as a result;
   False DTX detection can also lead to false ACK/NACK detection when Downlink Ack/Nack is embedded in the PUSCH.
      When the UE has uplink data as well as DL Ack/Nack to send, the Ack/Nack will be punctured in the PUSCH.
      However, with the SkipUplink feature, if the UE has no uplink data to send, the Ack/Nack will be transmitted over PUCCH. False PUSCH DTX detection can generate false results (False PUSCH may generate false downlink Ack/Nack) and interfere with the Ack/Nack detection in the PUCCH.
   LTE system is designed to target False detection rate of under 1% for control channels and 10% frame error rate (FER) for data channels (3GPP TS 36.141), therefore some false detection is unavoidable in practice. However, in light of the added ambiguity introduced by UplinkSkip, the present invention has identified that it is important to lower the false detection rate. Unreliable DTX-detection may make state tracking between eNB and UE out of sync. Unreliable DTX detection may also cause performance degradation in the serving cell, such as unnecessary retransmission requests, mission critical service (MCS) adjustments, power control etc. In addition, unnecessary transmissions also boost interference level to the neighboring cells.
2) Reliable DTX detection when a UE is at the cell edge is challenging due to higher level of interference. At a cell edge, the UE transmits at a higher power level due to power control. The same is true for an interferer in the nearby cell. This is schematically shown in FIG. 1 which shows a section of a wireless communication system 100. As can be seen a first UE 102 is served by Cell 1 106 which is provided by a first base station 110, and a second UE 104 is served by Cell 2 108 which is provided by second base station 112. If first UE 102 skips uplink transmission (DTX), but second UE 112 is transmitting on the same physical resource block (PRB), the second UE's signal (interference) can be mistaken as a signal coming from first UE 102, and thus cause DTX detection to fail in cell 1 106.
3) Multiple approaches are possible with proactive UL grant. These features can also benefit from SkipUplink feature if there is better reliability of DTX detection, For example:
   a. The eNB may use “dummy” UL grants (which are or are not “skippable”) with a goal of speeding up the transmissions to avoid latency.
   b. With SkipUplink, some fraction of the dummy UL grants will result in DTX. It is advantageous not to mistake DTX as UL data and incur retransmission as a result of PUSCH decode failure.
   c. Thus, as identified in the present invention, there is a need to improve the reliability of DTX detection rate in light of the skip-uplink feature. Not only because the DTX has ambiguity—it could be a miss-decoded grant or UE has nothing to send, but any false detection of DTX can make the state tracking between the base station and the UE “out of sync”. The additional ambiguity introduced by UplinkSkip may make the matter worse, and may require more steps to identify the “root cause” and make corrections to be “back in sync”.
4) One key 5G NR feature is URLLC (Ultra Reliable Low Latency Communication) for mission critical communications (e.g vehicle to infrastructure, vehicle to vehicle, public safety or industrial applications etc.). It is conceivable that proactive UL grant will be used as a measure to reduce latency. With SkipUplink feature, the UE will not send on the uplink if there is no UL data (to avoid interference to the neighbor cells). As a result, reliable DTX detection by base station (e.g. gNB in NR) may be useful in improving the latency and robustness of URLLC.

Furthermore, the present invention has identified that after a base station sends an uplink grant to a UE, then the following scenarios could feasibly happen:
If the UE receives the UL grant correctly, at the transmission time interval (TTI) that is specified by the UL grant:
   If the UE has uplink data, it will send the physical uplink shared channel (PUSCH) with Downlink Ack/Nack/CQI multiplexed in the channel if they coincide with the PUSCH transmission.
   If the UE has no uplink data but needs to send Ack/Nack or periodic CQI, it will send Ack/Nack/CQI in the physical uplink control channel (PUCCH) and DTX on PUSCH.
   If the UE has no uplink data but the channel quality indicator CQI Request bit is set to 1 (i.e. is on) in the UL grant, the UE will send the PUSCH that contains the aperiodic CQI report with the Ack/Nack multiplexed in it if they coincide with the PUSCH transmission.
   If the UE has no uplink data and there is no CQI request in the UL grant, the UE will send nothing (DTX).
If the UE fails to receive the UL grant, at the TTI that is specified by the UL grant:
   If the UE has uplink data, it will send Scheduling Request on the PUCCH if the SR configuration coincides with the expected UL transmission TTI.
   If the UE has no uplink data, it will send Ack/Nack/CQI on the PUCCH if the Ack/Nack/CQI configurations coincide with the expected UL transmission TTI.

A problem in all the above scenarios, which has been briefly mentioned above, is that the base station (e.g. eNB or gNB) will attempt to decode the PUSCH at the TTI specified by the UL grant as it has no knowledge of whether the UE has received the UL grant or not, or if the UE sends DTX (i.e. puts the UE in DTX mode) or not. As a result, reliable detection of DTX may be important in situations that require robust and low latency communications. It will be understood that the phrase “send DTX” may also be considered to mean “not send anything” (on that channel e.g. PUSCH).

As described above, there is a higher probability of false DTX detection when the UE is at the cell edge due to noise and interference from the neighbour cells. Cell edge UEs can be identified with the existing ULCoMP mechanism. Such mechanism may include, but is not limited to, measuring the signal to noise and interference ratio (SINR) of the UE transmission, estimating the path loss (e.g. via Power Headroom Report from the UE), analysing the RSRP/RSRQ (reference signal received power/reference signal received quality) of the neighbouring cell via the standard measurement report procedure, etc.

Through these measurements, the serving cell may identify one or more neighbouring cells that can help with the detection of the uplink signals of the serving-cell UEs at the cell edge. In other words, the serving cell may perform one or more measurements to identify one or more neighbouring cells suitable for assisting the serving cell in DTX detection of the serving cell UE. For the purposes of explanation, such neighbour cells may be referred to as “helper cells”.

Therefore the present invention has recognized that the new SkipUplink UE feature may introduce new required functionality in the base station receiver, and calls for a more reliable solution to detect the uplink transmission and DTX, especially in the case of high noise and interferences from neighbouring cells.

Accordingly, some examples propose using neighbouring cell measurements of the serving cell UE (and helper cell UE) to help improve the reliability of DTX detection for “serving cell” UEs that support the Skip Uplink feature in 3GPP R14 and beyond, without requiring joint detection.

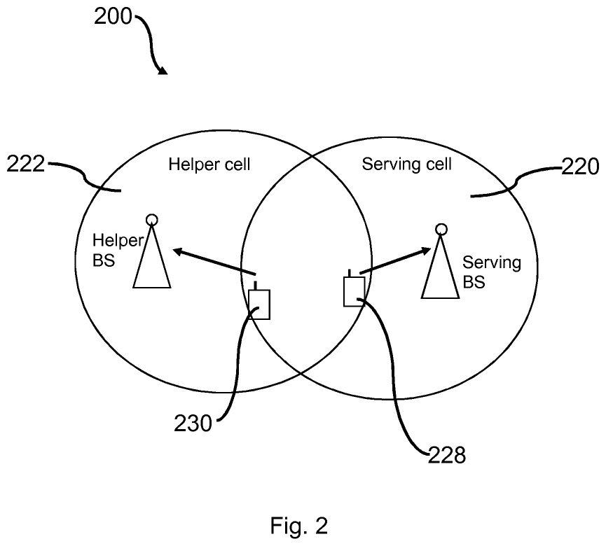

A description of FIG. 2 will now be provided to assist in understanding the invention. FIG. 2 shows schematically a part of a wireless communication system 200. The system 200 comprises a serving cell 220, and helper cell 222. Communication between the serving cell 220 and helper cell 222 can for example be inter-site. A serving cell UE 228 is shown in communication with serving cell 220 and a helper cell UE 230 is shown in communication with helper cell 222. The serving cell UE 228 refers to a UE connected to the serving cell, and is differentiated from a UE which is RRC connected to the neighbouring cell but which may be assigned to perform uplink transmission during a same PRB. In some examples the helper cell 220 has local knowledge of whether there is a helper-cell UE (e.g. UE 230) that transmits at the same time as the serving cell UE 228 using the same (or overlapping) PRBs. In some examples, the helper cell 222 is notified by the serving cell 220 of the PRB assignment of the serving cell UE 228, and determines that the helper cell 222 itself also has a helper cell UE 230 that use the same PRB (thus creates interference to each other on the Uplink).

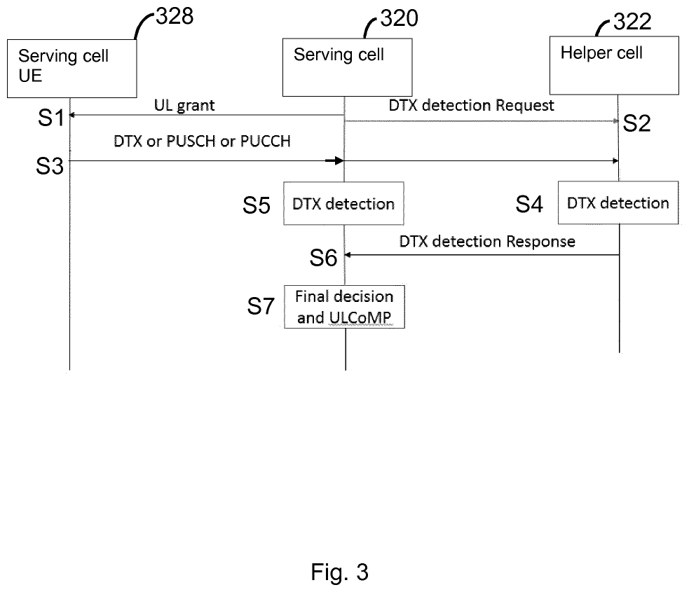

The invention can be further understood by reference to FIG. 3, which is a signaling diagram of a method according to an example, and shows communications between serving cell UE 328, serving cell 320 and helper cell (or neighbouring cell) 322.

At S1, serving cell 320 sends a UL grant to serving cell UE 328.

Subsequently, and as shown at S2, the serving cell 320 sends a DTX detection request message to helper cell 322 for the detection of the serving cell's UE 328 DTX. In some examples the serving cell 320 may also send the DTX detection request message to one or more other helper cells.

As shown at S3, the serving cell UE 328 performs DTX (or PUSCH or PUCCH) with serving cell 320.

As shown at S3, the serving cell UE 328 performs DTX (on PUSCH or PUCCH) with helper cell 322. Both serving cell 320 and helper cell 322 try to detect what was signalled (or DTXed) simultaneously, from their vantage point, as schematically shown by the overlapping arrows in FIG. 3.

As shown at S4, the helper cell 322 performs DTX detection. In some examples this comprises the helper cell 322 comparing a quality metric (e.g. signal to interference and noise ratio (SINR)) of its own helper cell UE (e.g. UE 230 in FIG. 2) with a quality metric (e.g. SINR) of the serving cell UE 328 (or 228 in FIG. 2).

The expectation is that the helper cell UE SINR (at the helper cell) will be higher, than would otherwise be the case, if the serving UE is in DTX because in that case the helper cell UE will not be suffering due to interference from the serving UE.

With respect to helper UE SINR at the helper cell:

If serving cell UE 328 is transmitting (not undertaking DTX), then expect lower SINR for that helper UE because of the interference it is suffering due to the serving UE.

In contrast if serving cell UE 328 is DTX, then expect higher SINR for that helper UE because of the lack of interference it is experiencing due to the serving UE being in DTX.

With respect to serving UE SINR at the helper cell:

If serving cell UE 328 is transmitting (not undertaking DTX), then expect higher SINR for the serving cell UE.

In contrast if serving cell UE 328 is DTX, then expect lower SINR for the serving cell UE.

So combining the above:

If serving cell UE 328 is transmitting (not undertaking DTX), then the difference would involve taking a lower SINR for helper UE—higher SINR for the serving UE.

In contrast if serving cell UE 328 is DTX, then the difference would involve taking a higher SINR for helper UE—lower SINR for the serving UE.

As a result, expect the difference to be larger if the UE DTX because (lower SINR for helper UE—higher SINR for the serving UE)<(higher SINR for helper UE—lower SINR for the serving UE).

The serving cell 320 also carries out its own DTX detection, as shown at S5.

As shown at S6, the helper cell 322 then sends a DTX detection response message. The DTX response message sends the result of the DTX detection carried out at S4 to the serving cell 320.

As shown at S7, the serving cell 320 then performs a determination or decision of whether it is an actual DTX of the serving cell UE 328. In order to do this, the serving cell 320 combines the DTX result received from the helper cell 322 with the serving cell's own DTX detection (i.e. the detection carried out at S5).

Some of the above aspects of FIG. 3 will now be explained in more detail.

With respect to S2, the DTX detection request contains:
information the helper cell needs to detect the serving-cell UE DTX (/transmission) in that subframe
frame/subframe number, the physical resource block (PRB) allocation of PUSCH, the PUSCH DMRS configuration,
DL Ack/Nack information and the CQI information (in those subframes where that applies),
PUCCH format and PUCCH DMRS configuration (for cases where missed UL grant or SkipUplink results in a PUCCH transmission that coincides with the subframe on UL grant)
SINR or Power Threshold criteria for use in DTX detection at the helper cell. Threshold Preferred Embodiment/Example Values:

DTX threshold would preferably be negative (below noise) as the most robust modulation coding (e.g. MCS 0) should support a negative SINR (e.g. ˜−4 dB based upon the corresponding FER curve). In other words, DTX threshold is preferably below the SINR of the lowest MCS. With fading impacts, it can be difficult to use a fixed DTX threshold and not have false detection.

When the serving UE DTXs, the difference between the helper UE SINR at the helper cell and the serving UE SINR at the helper cell in this example is ˜18 B
The relative threshold (difference between a) SINR of the helper UE measured at the helper cell, and b) the serving UE measured at the helper cell) is expected to be a “very” positive value when the serving UE sends DTX.
   This is because
When the serving UE DTX:
   The SINR of the helper UE seen by the helper cell at this time should be good (very positive, say, 10 dB at the cell edge) as there is no (or minimal) interference from the serving UE at the helper cell.
   The SINR of the serving UE seen by the helper cell at this time should be below noise (for example −8 dB)
   So this example would imply an 18 dB difference.
When the serving UE transmits (i.e. does not DTX), the difference between the helper UE SINR at the helper cell and the serving UE SINR at the helper cell in this example is ˜6 B, e.g. 3-(−3)=6 dB
   the SINR of the helper UE at the helper cell may (for example) approach 0 dB (similar to the serving UE) at the cell edge (although worse than that at handover can happen, for example helper UE SINR=−3 dB at the helper cell could occur when the other/serving cell is better).
   If for example the helper UE SINR is 3 dB, where the helper cell observes that the helper UE is 3 dB stronger than the serving UE which corresponds to the case where the serving UE SINR seen by the helper cell is approximately −3 dB because the serving UE is 3 dB weaker than the serving UE. So in this case the difference between the helper UE SINR at the helper cell and the serving UE SINR at the helper cell is 3-(−3)=6 dB.

Thereby in this case, the difference of 18 DB when the serving cell UE DTXs, is larger than the difference of 6 dB where the serving cell UE actually transmits.

In the above example, we take the case where the helper cell UE is receiving a grant which is not skipped (e.g. not skippable).

(If we continue the above example, then at the serving cell, the SINR of the serving UE may be ˜3 dB such that the serving cell observes that the helper UE is worse as it is further away from the serving cell.)

For the case where the PRBs allocated to the serving cell UE overlap with two different helper UEs, the approach applies what was described above, with each of the two helper cell UEs' PRB regions overlap with the serving UE's PRB.

In other words, what is discussed above still applies, e.g. where the interference produced by the serving UE when it transmits will impact the SINR observed at the helper cell for each of the helper UEs.

At the subframe which is specified by the UL grant, the serving cell 320 and the helper cell 322 shall expect a transmission from the serving-cell UE 328. As described above, depending on whether the UE 328 has successfully received the UL grant, whether the UE has data to send, or whether the UE has uplink control information (CSI or Ack/Nack etc) that coincide with the subframe, the level of noise and interference, etc., there are several potential outcomes that the serving cell as well as the helper cell need to check.

At the subframe specified by the UL grant, the serving cell 320 will detect PUSCH transmission as well as possible PUCCH transmission from the serving-cell UE 328 through estimating one or more qualities of the signals from antennas of the serving cell.

The helper cell 322 will then detect the uplink PUSCH transmission of the serving-cell UE 328 based on the information from the DTX detection request (S2), using signals from the helper cell antennas.

In some examples this shall include,
sending the helper data signals that correspond to the serving-cell UE PUSCH physical resource block allocation to the PUSCH receiver,
estimating the quality of signal based on the serving-cell UE PUSCH DMRS (demodulation reference signal) configuration (e.g. channel power estimation, noise power estimation, interference estimation, signal to noise and interference ratio, etc.).

Such detection of PUSCH transmission may include a DTX detection step (S5) at the helper cell 322, for example by comparing one or more signal qualities against a threshold. When the signal quality is below the threshold, it may be concluded that a DTX is detected. Otherwise, an actual transmission of PUSCH signal from the serving-cell UE 328 is detected.

Additionally, the helper cell 322 may have knowledge of whether a helper-cell UE (e.g. UE 230 in FIG. 2) is also transmitting using the same physical resources in the same subframe as the serving cell UE 230.

If the helper-cell UE 230 is transmitting using the same physical resources in the same subframe as the serving cell UE 328, then:
the helper cell 322 compares the signal quality (e.g. SINR) of the helper-cell UE 230 transmission with that of the serving-cell UE.
helper cell compares this difference (i.e. difference between serving cell UE 228/328 SINR and helping cell UE 230 SINR) against another (i.e. second) threshold to help with DTX detection.

For example:
If both serving-cell UE 228 and the helper-cell UE 230 transmit PUSCH signals, the signals will interfere with each other, so that the SINR measurement for both UEs would be low;
Conversely, if the serving-cell UE sends DTX due to UplinkSkip or mis-detection of the UL grant, the SINR of the helper-cell UE 230 would be significantly higher as it has no interference, whereas the SINR of the serving-cell UE 228 would be significantly lower.
Such threshold (i.e. the “second” threshold referred to above) may be either configured by the serving cell 320 as described in the DTX detection request. In other examples the second threshold can be configured by the helper cell).

In some examples, if the helper cell 326 is (also) instructed in the DTX detection request (S2) to handle the uplink PUCCH transmission of the serving-cell UE, then:
The helper cell 322 will detect the uplink PUCCH transmission of the serving-cell UE 328 using signals from the helper cell antennas.
In some examples this shall include sending helper data signals that correspond to serving-cell UE PUCCH allocation to the helper-cell PUCCH receiver, where the signal quality is measured (e.g. channel power estimation, noise power estimation, interference estimation, signal to noise and interference ratio, etc.), based on the serving-cell UE PUCCH DMRS configuration in the DTX detection request.

Such calculation may also include the DTX detection step (S4 and/or S5), where one or more signal quality or power is compared against a threshold, as described above.

If the signal quality is below the threshold, it can conclude that a DTX in PUCCH is detected, otherwise, an actual PUCCH transmission from the serving-cell UE is detected.

In addition, the helper cell 322 has knowledge of whether a helper-cell UE 230 is also transmitting PUCCH using the same physical resources in the same subframe.

In this case, the helper cell 322 can compare the signal quality (e.g. signal to noise and interference ratio (SINR)) of the helper-cell UE 230 transmission with that of the serving-cell UE 328. The helper cell 322 can then compare that difference against another threshold to help with DTX detection. For example, if both serving-cell UE 228 and the helper-cell UE 230 transmit PUCCH signals, the signals will interfere with each other, thereby the SINR measurement for both UEs would be low. Conversely, if the serving-cell UE 228 does not send PUCCH, the SINR of the helper-cell UE 230 would be significantly higher as it has no interference while the SINR of the serving-cell UE 228 would be significantly lower. Such a threshold can be configured by the serving cell 320 in the DTX detection request. In another example the threshold can be configured by the helper cell 322 alone.

As shown at S6 in FIG. 3, in some examples the helper cell 322 informs the serving cell 320 of the result of the detection through a DTX detection response. Such a response may include, and is not limited to, the DTX detection results (e.g. DTX or non-DTX, i.e. signal detected) from the PUSCH receiver as well as PUCCH receiver if instructed in the DTX detection request (S2), the signal quality measurements etc. In the case of a non-DTX detection, either in PUSCH or PUCCH, the helper cell 322 will send the corresponding-UL CoMP helper data signals to the serving cell 320 for uplink joint reception. In some examples this is achieved by pooling antenna signals from both the serving cell 320 and the helper cell 322. In some examples advanced receiver, e.g. IRC (Interference Rejection Combining) receiver can be used to further exploit the spatial diversity of the signals by boosting the desired signals while suppressing the interference signals.

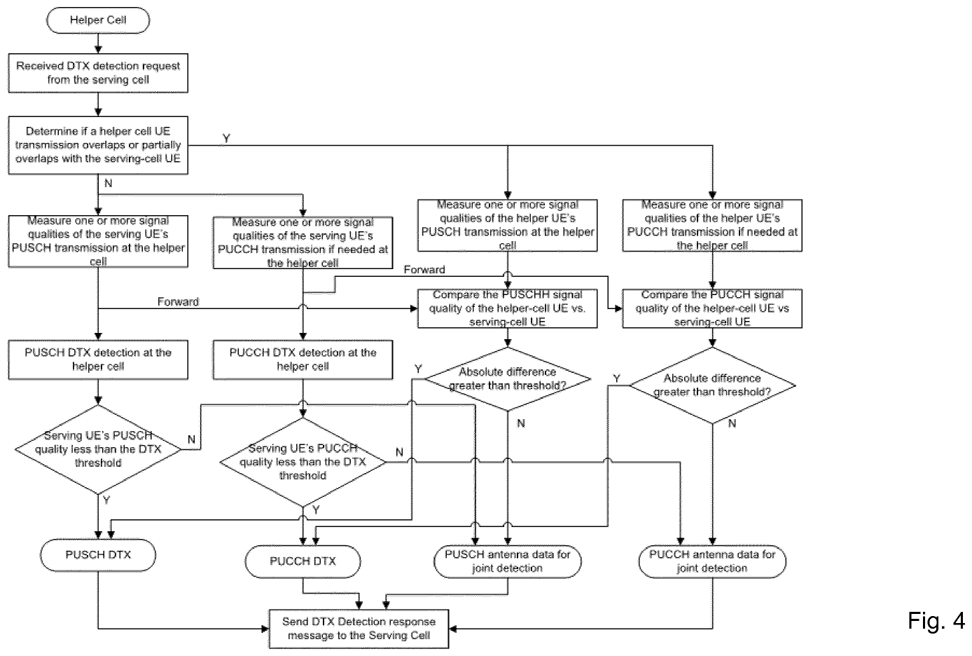

The above-described steps which are carried out by the helper cell 322 are also schematically shown in the flow-chart of FIG. 4. For conciseness, description of these steps is not repeated in detail. FIG. 4 further assists in showing how the steps relate to each other. It can be seen from FIG. 4 that by the described mechanisms the helper cell 322 can determine whether a UE of a serving cell has antenna data to send (PUSCH or PUCCH), or is in DTX (PUSCH or PUCCH). The helper cell 322 can then send this information to the serving cell in the DTX detection response, as shown in the last step of FIG. 4 (cf with S6 of FIG. 3).

In some examples, the serving cell 320 waits for the detection results from the helper cell 322 through the DTX detection response message (S6 in FIG. 3), and combines the helper cell result with its own result (from DTX detection at S5 in FIG. 3) before making the final decision of the uplink detection.

For example, if both helper cell 322 and serving cell 320 detect DTX for PUCCH or PUSCH, this provides a better confidence that DTX has happened. Therefore the decision is more robust than if made by the serving cell 320 alone.

As another example, if both helper cell 322 and the serving cell 320 detect PUSCH or PUCCH transmission, this gives more confidence that an actual transmission from the serving-cell UE 328 has happened.

In a case where the detection result from the serving cell 320 and detection result from the helper cell 322 do not agree, a final detection decision can be made through joint reception. For example the final detection can be made by using pooled signals from both serving cell 320 and helper cell 322 antennas. Joint reception exploits the spatial diversity of the signals and uses advanced receivers to suppress interference and thereby improves the robustness of the detection.

If the helper cell 322 provides UL CoMP data, the helper data and the serving cell data can be pooled together and be processed by advanced receiver (e.g. IRC), where a newer measurement of the signal quality (e.g. signal power measurement or SINR measurement) can be obtained (UL CoMP data can be post FFT frequency domain data or before FFT time domain data. In the latter case, the serving cell can convert the time domain data back into frequency domain before further processing). The newly obtained signal quality can be used to compare against a threshold for a more robust DTX detection.

In some examples the helper cell decision is used to influence the serving cell decision. For example, if the helper cell indicates the UE likely DTXed then serving cell's SINR or power threshold for determining if the UE DTXed may be shifted or changed (in response to the neighbor indication of likely DTX), where that shift makes it more likely the serving cell concludes the UE DTXed.

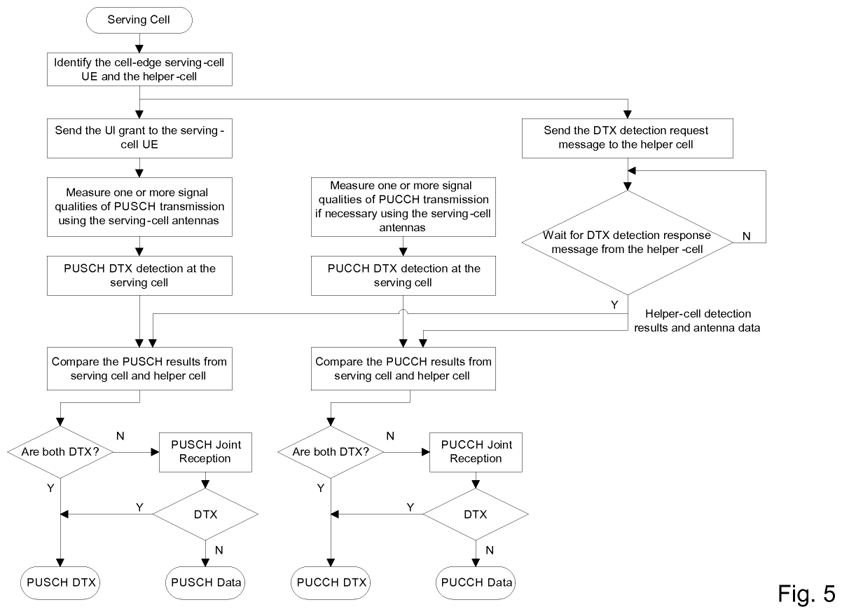

The flow chart of FIG. 5 represents the method steps carried out by the serving cell 320, as described above. Again, for conciseness these steps are not repeated in detail. FIG. 5 assists in showing how these steps relate to each other. From FIG. 5 it can be further seen that ultimately the serving cell 320 can, using the described mechanisms, detect whether a UE 328 of the serving cell has data to send (PUSCH or PUCCH), or is in DTX (PUSCH or PUCCH).

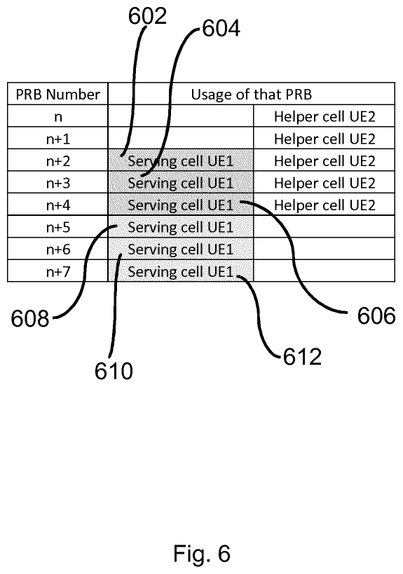

Now with reference to FIG. 6, this shows an example of PRB number, n, against usage of that PRB. In a case where the serving cell UE has some PRBs which overlap (cells 602, 604 and 606 in FIG. 6) with the neighbour cell UE, and some PRBs that do not overlap (cells 608, 610 and 612 in FIG. 6), then both of the mechanisms described above (FIG. 4 and FIG. 5) can be practiced for a same UE.

Furthermore, in some examples the helper cell combines the DTX estimate for the serving cell UE across the two regions (602, 604, 606; and 608, 610, 612), in the context of the above. The serving cell may combine the DTX estimate for that UE across the two regions (602, 604, 606; and 608, 610, 612), e.g. where the neighbour cell sent the UL CoMP helper data.

It will be understood that the examples may enable leveraging neighbour cell measurements to locally detect potential DTX (before concluding in the serving cell) of PUSCH and potential PUCCH transmission due to lack of UL data or failure to detect UL grant by the UE. Furthermore interworking between serving cell and one or more neighbour cells is facilitated where a decision by the neighbour cell is sent back to the serving cell for final determination. In addition, in the case of non-DTX detection, the neighbour cell shall send the data back to the serving cell for traditional ULCoMP (e.g. IRC receiver) on the PUSCH or the PUCCH to reduce the interference.

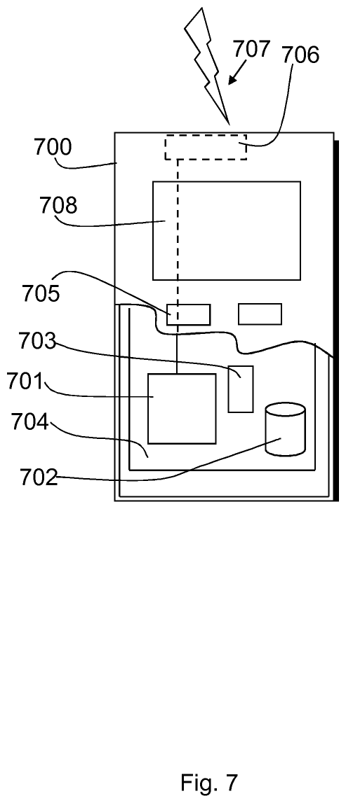

A possible wireless communication device which may operate in examples of the present invention will now be described in more detail with reference to FIG. 7 showing a schematic, partially sectioned view of a communication device 700. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 700 may receive signals over an air or radio interface 707 via appropriate apparatus for receiving and may transmit signals via appropriate apparatus for transmitting radio signals. In FIG. 7 transceiver apparatus is designated schematically by block 706. The transceiver apparatus 706 may be provided for example by means of a radio part and associated antenna arrangement. The antenna arrangement may be arranged internally or externally to the wireless device.

A wireless device is typically provided with at least one data processing entity 701, at least one memory 702 and other possible components 703 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 704. The user may control the operation of the wireless device by means of a suitable user interface such as key pad 705, voice commands, touch sensitive screen or pad, combinations thereof or the like. A display 708, a speaker and a microphone can be also provided. Furthermore, a wireless communication device may comprise appropriate connectors (either wired or wireless) to other devices and/or for connecting external accessories, for example hands-free equipment, thereto. The communication devices 702, 704, 705 may access the communication system based on various access techniques.

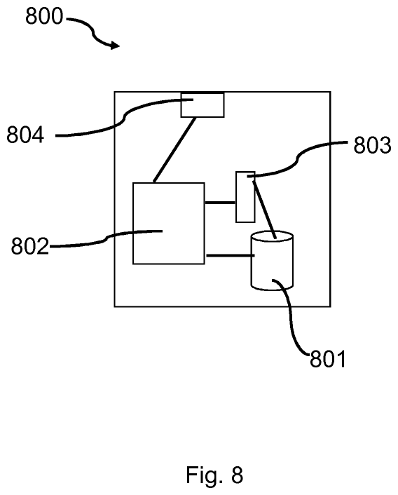

FIG. 8 shows an example of a control apparatus 800 which may operate in examples of the present invention. The control apparatus may be for example a RAN node, e.g. a base station, such as an eNB or a gNB, a central unit of a cloud architecture or a node of a core network such as an MME or S-GW, a scheduling entity such as a spectrum management entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 800 can be arranged to provide control on communications in the service area of the system. The control apparatus 800 comprises at least one memory 801, at least one data processing unit 802, 803 and an input/output interface 804. Via the interface the control apparatus can be coupled to a receiver and a transmitter of the base station. The receiver and/or the transmitter may be implemented as a radio front end or a remote radio head. For example the control apparatus 800 or processor 801 can be configured to execute an appropriate software code to provide the control functions.

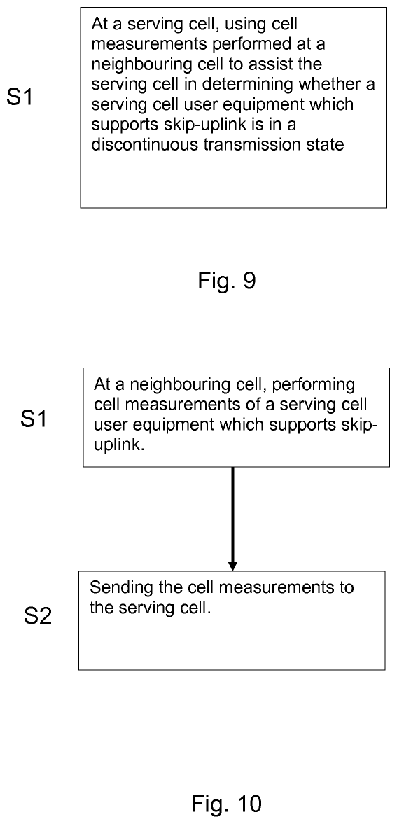

FIG. 9 schematically shows a method according to an example. The method is performed at a serving cell. The method may be performed at an apparatus. For example the method may be performed at a base station.

At S1 the method comprises, at a serving cell, using cell measurements performed at a neighbouring cell to assist the serving cell in determining whether a serving cell user equipment which supports skip-uplink is in a discontinuous transmission state.

According to examples the cell measurements performed at the neighbouring cell comprise measurements of the serving cell user equipment.

According to some examples, prior to S1, the serving cell receives the cell measurements from the neighbouring cell.

FIG. 10 schematically shows a method according to an example. The method is performed at a neighbouring cell. The method may be performed at an apparatus. For example the method may be performed at a base station.

At S1, the method comprises, at a neighbouring cell, performing cell measurements of a serving cell user equipment which supports skip-uplink.

At S2, the method comprises sending the cell measurements to the serving cell.

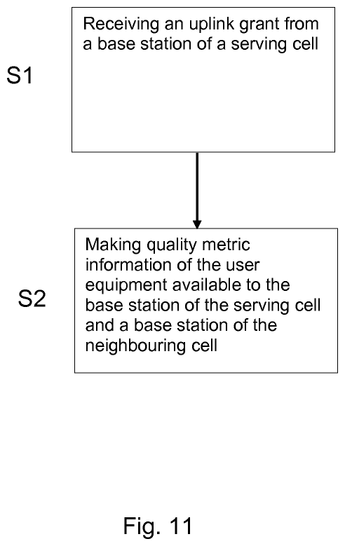

FIG. 11 schematically shows a method according to an example. The method is performed at a user equipment.

At S1 the method comprises receiving an uplink grant from a base station of a serving cell.

At S2 the method comprises making quality metric information of the user equipment available to the base station of the serving cell and a base station of a neighbouring cell.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
at a serving cell, receiving cell measurements performed at a neighbouring cell; and
at the serving cell, using the cell measurements performed at the neighbouring cell to assist the serving cell in determining whether a serving cell user equipment, which supports skip-uplink, is in a discontinuous transmission state, wherein the cell measurements performed at the neighbouring cell comprise measurements of the serving cell user equipment.

2. A method according to claim 1, comprising the serving cell performing cell measurements of the serving cell user equipment, and the determining whether the serving cell user equipment is in a discontinuous transmission state comprises performing a comparison of the cell measurements performed with the serving cell and the cell measurements performed at the neighbouring cell.

3. A method according to claim 2, comprising determining that the serving cell user equipment is in the discontinuous transmission state when both the cell measurements performed with the serving cell and the cell measurements performed at the neighbouring cell indicate that the serving cell user equipment is in a discontinuous transmission state.

4. A method according to claim 2, comprising performing a joint reception procedure at the serving cell to determine whether the serving cell user equipment is in a discontinuous transmission state, when only one of the cell measurements performed with the serving cell and the cell measurements performed at the neighbouring cell indicate that the serving cell user equipment is in a discontinuous transmission state.

5. A method according to claim 4, wherein the joint reception procedure comprises pooling antenna signals of the serving cell and the neighbouring cell.

6. A method according to claim 1, wherein the method comprises the serving cell sending a request to the neighbouring cell to perform the cell measurements of the serving cell user equipment.

7. (canceled)

8. A method according to claim 1, wherein the determining whether a serving cell user equipment which supports skip-uplink is in a discontinuous transmission state comprises using a received indication from the neighbouring cell, wherein the received indication explicitly indicates whether the neighbouring cell considers the serving cell user equipment to be in the discontinuous transmission state.

9. (canceled)

10. A method comprising:
at a neighbouring cell, performing cell measurements of a serving cell user equipment which supports skip-uplink; and
sending the cell measurements to the serving cell, the cell measurements sent to the serving cell being indicative of whether the serving cell user equipment is in a discontinuous transmission state.

11. A method according to claim 10, wherein the performing cell measurements comprises the neighbouring cell further performing cell measurements of a neighbouring cell user equipment, and comparing a quality metric of the neighbouring cell user equipment and the serving cell user equipment.

12. A method according to claim 11, wherein the quality metric comprises a signal to interference and noise ratio.

13. A method according to claim 11, comprising determining a difference in the quality metric between the neighbouring cell user equipment and the serving cell user equipment, and comparing the difference to a threshold value in order to assist in determining whether the serving cell user equipment is in a discontinuous state.

14. A method according to claim 10, wherein the performing cell measurements comprises the neighbouring cell measuring an absolute value of signal to interference and noise ratio of the serving cell user equipment, when it is determined with the neighbouring cell that there is no neighbouring cell user equipment whose scheduling grant overlaps with that of the serving cell user equipment.

15. A method according to claim 10, comprising the neighbouring cell providing an explicit indication to the serving cell of whether the neighbouring cell considers the serving cell user equipment to be in the discontinuous transmission state.

16. (canceled)

17. A method comprising:
at a user equipment which supports skip-uplink in a serving cell, receiving an uplink grant from a base station of the serving cell; and
making quality metric information of the user equipment available to the base station of the serving cell and a base station of the neighbouring cell to assist in determination of whether the user equipment is in a discontinuous transmission state.

18. A non-transitory computer readable medium encoded with a computer program comprising instructions for causing an apparatus to perform at least the method as claimed in claim 1.

19. A non-transitory computer readable medium encoded with a computer program comprising instructions for causing an apparatus to perform at least the method as claimed in claim 10.

20. A non-transitory computer readable medium encoded with a computer program comprising instructions for causing an apparatus to perform at least the method as claimed in claim 17.

21. An apparatus comprising circuitry comprising at least one processor and at least one non-transitory memory including computer program code, the at least one memory and the computer program code configured to, with the at least one processor, cause the apparatus to perform:
at a serving cell, using cell measurements performed at a neighbouring cell to assist the serving cell in determining whether a serving cell user equipment which supports skip-uplink is in a discontinuous transmission state, wherein the cell measurements performed at the neighbouring cell comprise measurements of the serving cell user equipment.

22. An apparatus comprising circuitry comprising at least one processor and at least one non-transitory memory including computer program code, the at least one memory and the computer program code configured to, with the at least one processor, cause the apparatus to perform:
at a neighbouring cell, performing cell measurements of a serving cell user equipment which supports skip-uplink, and sending the cell measurements to the serving cell, the cell measurements sent to the serving cell being indicative of whether the serving cell user equipment is in a discontinuous transmission state.

23. An apparatus comprising circuitry comprising at least one processor and at least one non-transitory memory including computer program code, the at least one memory and the computer program code configured to, with the at least one processor, cause the apparatus to perform:
at a user equipment which supports skip-uplink in a serving cell, receiving an uplink grant from a base station of the serving cell, and making quality metric information of the user equipment available to the base station of the serving cell and a base station of the neighbouring cell to assist in determination of whether the user equipment is in a discontinuous transmission state.
